(19) United States
(12) Patent Application Publication
(10) Pub. No.: US 2021/0347083 A1
(43) Pub. Date: Nov. 11, 2021

(54) A MACHINE FOR COLLECTING, FROM A CUT PANEL FOR OBTAINING PREDETERMINED ARTICLES, THE ARTICLES AND SCRAPS GENERATED BY THE CUTTING OF THE PANEL AND A MACHINE FOR ACTUATING THE METHOD

(71) Applicant: ELITRON IPM S.R.L., MONTE URANO (FM) (IT)

(72) Inventor: Giuseppe GALLUCCI, MONTE URANO (FM) (IT)

(21) Appl. No.: 17/283,887

(22) PCT Filed: Oct. 9, 2019
(86) PCT No.: PCT/IB2019/058587

§ 371 Date: Apr. 8, 2021

(30) Foreign Application Priority Data
Oct. 15, 2018 (IT) 102018000009340

(51) Int. Cl. B26D 7/18; B26D 7/06

(52) U.S. Cl. CPC B26D 7/1836; B26D 7/1863; B26D 2007/0018; B26D 2007/189; B26D 7/0625

(57) ABSTRACT

A method for collecting, from a cut panel for obtaining predetermined articles, the articles and scraps generated by the cutting of the panel comprising following steps: making available a cut panel (P) in which predetermined articles (A) and scraps (S) are defined; having available an electronic processor; having available at least a cutting file in which the dimensions, positioning and orientation of the articles (A) and scraps (S) are defined; memorising the cutting file in the electronic processor; positioning the cut panel (P) on a support of a first station; removing, in accordance with the indications of the cutting file, at least one scrap (S) at a time from the cut panel (P) by separating the adjacent cut articles and/or scraps, without altering the orientation and mutual positioning of both thereof, with a subsequent transfer of the at least a scrap (S) into a scrap collecting station.

### FIELD OF THE INVENTION

The invention relates to the technical sector concerning the collecting, from a cut panel for obtaining predetermined articles, of the articles and scraps generated by the cutting of the panel.

### DESCRIPTION OF THE PRIOR ART

Pick-up systems are known which, following the cutting of the panels in a relevant station, collect the panels, including the articles and the scraps, and then position them in a collection store to define the stacks of cut panels: the stacks of panels comprise stacks of cut articles and stacks of scraps.

FR 2 795 014 describes a process for cutting and automatic unloading of stacks of pieces in a mattress formed by superposed layers of sheet material, comprising: the cutting of the stacks of pieces in a mattress on a cutting table, starting from information memorised that relates to the positioning of the pieces on the surface of the mattress, and the unloading of the stacks of pieces by means of at least an automatically-piloted unloading tool, the fractioning of the scraps of the mattress, in several parts during the cutting of the stacks of pieces on the cutting table; the progressive transfer, above an unloading table, of the mattress comprising the stacks of cut pieces and the scrap of the mattress, not separated from one another and the subsequent unloading of the stacks of cut pieces following the movement of the unloading tool in order to bring the tool into contact with the stacks that have arrived on the unloading table, using the information relative to the positioning of the pieces to the surface of the mattress, in order to disengage each stack from the rest of the mattress by a displacement to a great degree parallel to the plane of the mattress without interfering with the stacks of pieces not yet unloaded, the stacks of cut pieces and the parts of the scrap of the mattress being unloaded in such a way as to disengage the passage onto the unloading table for the stacks of pieces and the parts of scrap not yet unloaded.

The stacks of cut pieces and the relative scraps are, by definition, unloaded together.

FR 2 507 948 describes a plate made of a rigid or semi-rigid material, from which are cut pieces constrained to the plate at the periphery thereof.

In a first station the pieces, by the combined action of the blower means and suction means, are detached from the plate and, thereafter, transferred to a second station where they are arranged in stacks.

In a further known solution, in successive operating steps of the operators act on every stack of panels to divide the scraps from the articles, but this is a particularly laborious operation.

First the operators remove, from the stack of panels, the stacks of scraps present in proximity of the perimeter edge thereof, then to proceed towards the central zone of the stack of panels in order to gradually collect the accessible articles, then to eliminate the stacks of scraps trapped in centre of the stack of panels.

If the panels are of large size, stacks of heavy and voluminous panels are created, and collecting the stacks of articles will be even more problematic.

With these panels, the dimensions of the scraps can also be large and the stacks of scraps that are created are consequently heavy and difficult to move and dispose of; therefore, and preferably at the moment of cutting the panels, or afterwards, additional engravings are carried out on the scraps, or stacks of scraps, to reduce the dimensions thereof and consequently reduce the dimensions of the stacks of scraps in order that they can then be removed.

During the displacement of the stacks of scraps, a part of the stacked articles in adjacent stacks can also be moved, with all the drawbacks that this leads to in terms of time for the re-stacking of the articles and for the movement of the stacks of articles for the successive work operations.

### SUMMARY OF THE INVENTION

The aim of the present invention is to provide a method that obviates the above-mentioned drawbacks and in particular a method enabling removal of the scraps following the cutting of panels in order to obtain predetermined articles.

A further aim of the invention is to provide a method comprising operating steps that are particularly simple and rapid, which enables the unloading of the collected scraps in a predefined collection zone.

A still further aim of the invention is to provide a method which enables collection, from the cut panels, of only the articles in order to enable stacking thereof in an article collecting station.

A further aim of the invention is to provide a machine conceived to actuate the method of the invention.

The above-mentioned advantages of the invention are obtained according to the contents of the claims.

### BRIEF DESCRIPTION OF THE DRAWINGS

The characteristics of the invention are specified in the following which includes a preferred, but not exclusive, embodiment, with reference to the accompanying tables of drawings, in which:

FIGS. 1-4 illustrate four perspective views of a machine, schematically represented with its significant components, with which to actuate a method for collecting, from a cut panel for obtaining predetermined articles, the articles and scraps generated by the cutting of the panel.

### DESCRIPTION OF THE PREFERRED EMBODIMENTS

With reference to the figures, reference numeral (1) denotes a machine with the relative significant components schematically represented.

The machine is supplied in a stepped mode, in a known way, with cut panels (P) in each of which articles (A) are defined, having a predetermined extension, profile and orientation; the zones not affected by the articles (A) constitute the scraps or filings (S).

The machine comprises a first station (2), destined to receive the cut panels, and a second station (3), consecutive to the first station, on which the articles (A) of each panel are deposited, as will be explained more fully in the following.

The first station (2) comprises a support constituted by a first mat conveyor (20), for example of the looped type, activated in advancement direction (X), in a way known to the expert in the sector.

The station is associated to a scrap removal and unloading unit (5), operating above the first mat conveyor (20).

The unit (5) comprises a first device (90) for removing the scraps (S) from the cut panel (P) located on the first mat conveyor (20), and a second device (100) which receives the scraps (S) of the first device (90), then to direct the scraps (S) towards a collecting station (150) located externally of the first station (2); both of the devices are supported in a way known to the expert in the sector and activated, transversally to the advancement direction (X), in mutual phase relation (for example in synchrony) upstream (towards J₁) and downstream (towards J₂) according to systems known to the expert in the sector.

The first device (90) comprises: a beam (50), transversal to the advancement direction (X), comprising two parallel guides (40A, 40B), transversal to this direction; two skates (41, 42), sliding on the guides in both directions (F₁, F₂), made mobile independently by known means, not illustrated; two longitudinal bars (43, 44), perpendicular to the guides (40A, 40B) and parallel to the advancement direction (X), each supported by a corresponding skate (41, 42); two pick-up groups (6), each of which is borne by a corresponding bar (43, 44).

Each pick-up group comprises: a carriage (7) sliding (directions Y₁, Y₂) on the corresponding bar (43, 44); a rod (8), borne by the carriage (7) and vertically sliding (directions Z₁, Z₂) by known means, not illustrated, the lower end of the rod 8 comprising a gripping means (9), for example a known-type needle-nose gripper or known suction means; the gripping means (9) can rotate, in both directions, with respect to a vertical axis.

The second device (100) comprises a second mat conveyor (30), for example of the looped type, the upper branch of which is activated in direction (H) transversal to the advancement direction (X) of the first mat conveyor (20).

The second station (3) comprises a base (75) identified, for example, by the upper part of an elevator (70), for example of the pantograph type.

A collecting organ (80) cooperates with the second station (3), for example an aspirating plane, of known type, with the aspirating face facing downwards.

The collecting organ (80) is supported and longitudinally moved in both directions (K₁, K₂) parallel to the advancement direction (X), and vertically, in directions (I₁, I₂), utilising methods known to the expert in the sector. Also included is a rotation according to a vertical axis and in both directions of the collecting organ (80).

The machine (1) further comprises an electronic processor, not illustrated, in which a file coinciding with the cutting file of the panels is memorised, in which information relating to the dimensions, positioning and orientation of the cut articles (A) and the scraps (S) relative to the cut panels (P) is stored; the processor is arranged for controlling, and managing, all the devices, units, means or anything else relating to the machine so as to actuate the method of the invention.

In an application of the method, the inlet portion (21) of the first mat conveyor (20) is aligned to and close by the outlet portion of a transporter which feeds the cut panels (P) to the machine (1) and the cutting file used to cut the panels is memorised in the electronic processor.

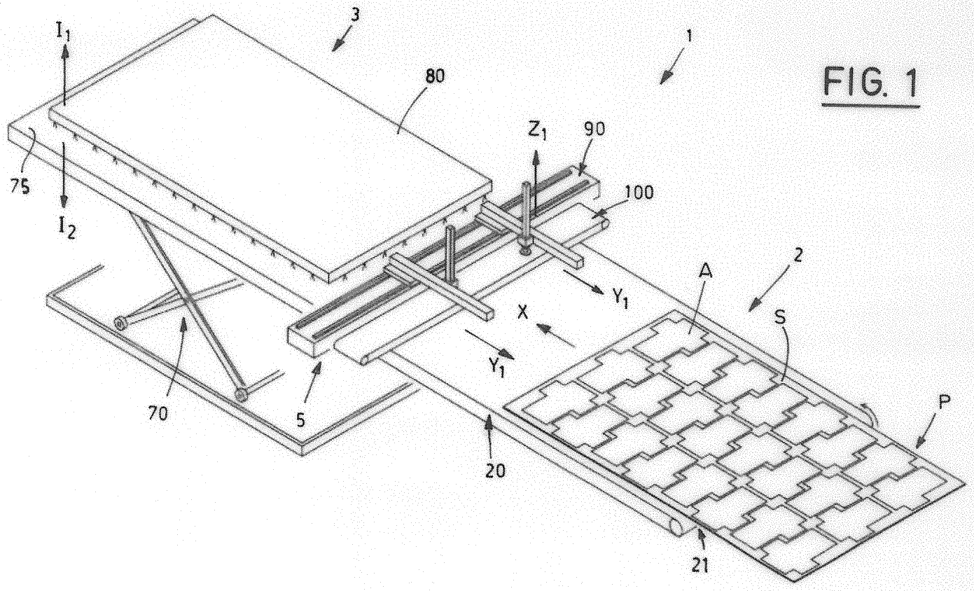

In a non-operating position of the machine (1), as illustrated in FIG. 1, the scrap removal and unloading unit (5) is arranged at the other end of the first mat conveyor (20) and the collecting organ (80) is positioned in said second station (3) above the base (75) (FIG. 1).

A cut panel (P) is positioned on the upper branch of the first mat conveyor (20), activated in the advancement direction (X) of FIG. 1, which cut panel (P) comprises a series of articles (A) and the relative scraps (S); this cut panel (P) advances and is detected by a detecting means, not illustrated, to determine the positioning of the first mat conveyor (20) below the unit (5) and the blocking of the advancement thereof.

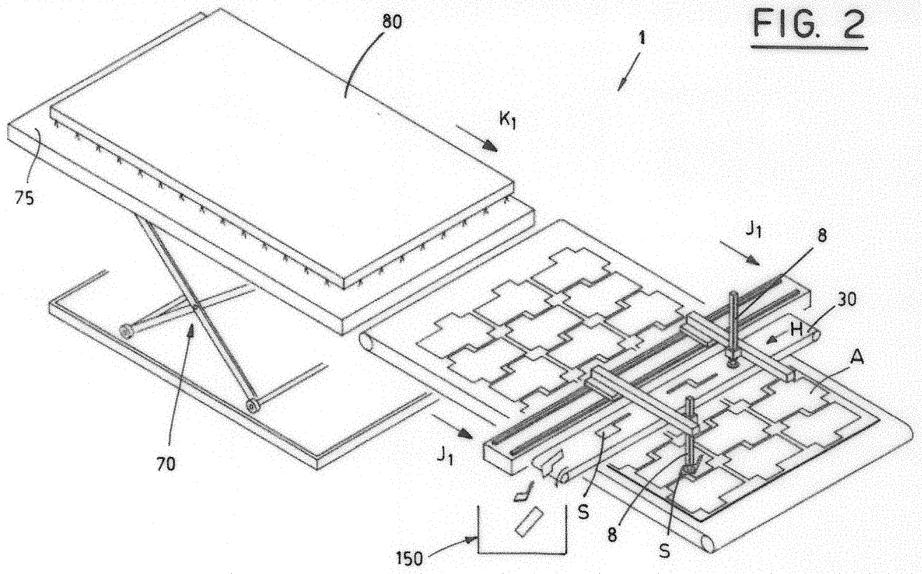

As a function of the information in the cutting file, the processor moves the unit (5) upstream in direction J₁ (FIG. 2), activating both the skates (41, 42) and each pick-up group (6) in order to position them in proximity of the scrap/s (S) to be removed located along a first transversal strip of the panel (P).

The gripping means (9) will thus be controlled by the electronic processor in order to be positioned above a corresponding scrap (S) orientated with respect to the vertical axis, as a function of the dimensions and orientation of the scrap (S) to be removed, and, lastly, activated downwards according to direction (Z₂) to engage the scrap (S).

Thereafter, the gripping means (9) is moved vertically upwards (direction Z₁), as well as longitudinally towards J₂, in order to be positioned above the second mat conveyor (30) so as to allow the consequent release of the scrap (S) thereon.

In the described embodiment the second mat conveyor (30) will be activated to operate continuously and direct the scraps (S) into the collecting station (150).

The second mat conveyor (30) can alternatively be activated following the removal of all the scraps (S) which will be unloaded in the station (150). Following the removal and unloading of the scraps (S) along the first transversal strip of the panel (P), the unit (5) will be newly moved upstream in direction J₁ in order to operate as described in the foregoing, in order to release further scraps (S) onto the second mat conveyor (30) up to removing all the scraps (S) from the cut panel (P).

The collecting organ (80), in a first embodiment, is moved in phase relation with the movement of the unit (5), to be positioned, at the same time as the removal and unloading of all the scraps (S), above the series of articles (A) positioned resting on the first mat conveyor (20).

In a second variant the movement of the collecting organ (80) is activated following the termination of the removal and unloading of all the scraps (S) in order to be positioned above all the articles (A) positioned resting on the first mat conveyor (20).

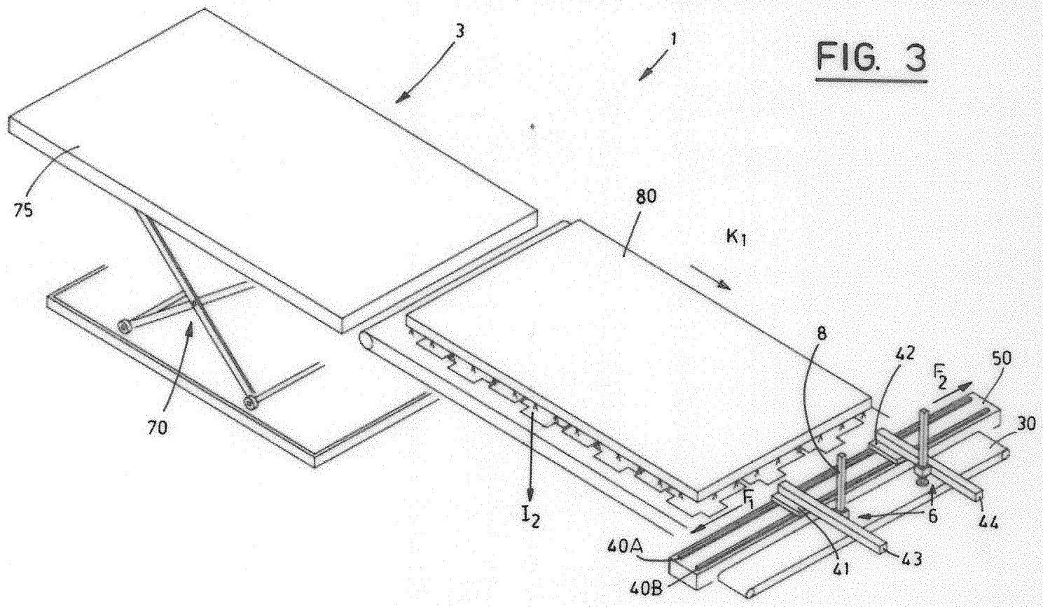

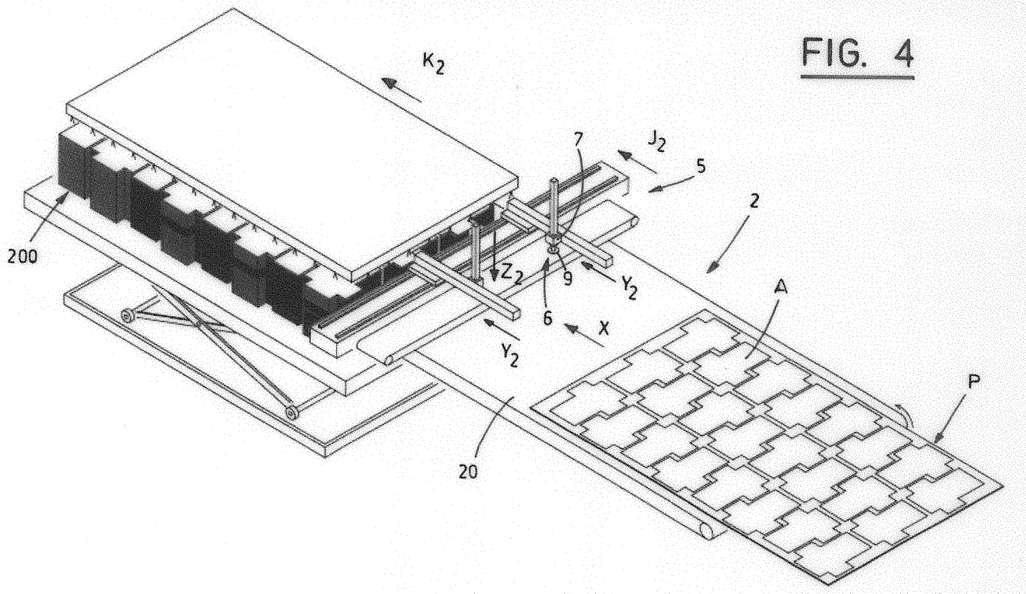

The collecting organ 80 will consequently be moved vertically downwards according to the direction I₂ (FIG. 3) to abut the articles (A) and, in phase relation, an aspiration source is activated to engage all the articles (A) to the aspirating face of the collecting organ (80), first moved vertically upwards (direction I₁) and, subsequently, activated longitudinally (direction K₂) in order to be repositioned above the base (75).

The collecting organ (80) will newly move vertically downwards (direction I₂) in order to release the articles (A) on the base (75) to define a first layer of a series of stacks of cut articles (A), each stack (200) being constituted by identical and superposed articles (A).

The method of the invention is particularly advantageous, as it enables, following the cutting of the panels to obtain predetermined articles (A), the removal of the scraps (S) from the panels and unloading the scraps in a collecting station, and, successively, the contemporary collecting of all the cut articles (A) in order to be able to position them on the base (75) of the elevator (70) to create on the elevator (70), at the same time, stacks of cut articles (A), destined to a subsequent storage or to subsequent work operations on the articles (A).

The method enables, following the use of the cutting file utilised for the cutting of the panels, controlling the devices, organs and units included in the machine used for actuating the cutting file.

The method, in fact, includes, following the positioning of the cut panel (P) on the first mat conveyor (20) and the positioning thereof below the unit (5), the activation of at least one gripping means (9) for removing, according to the indications of the cutting file, at least one of the scraps (S) included on the panel (P), separating the cut articles (A) so that the articles remain resting on the first mat conveyor (20), and also includes the gripping means (9) being activated to unload at least the scrap (S) on the second mat conveyor (30) which, following activation thereof, directs the scrap into the collecting station (150) external of the first station (2).

The fact of removing the scraps (S) according to the indications of the cutting file is advantageous, as the scraps (S) can be engaged and removed easily from the single panel (P), enabling the articles (A) to maintain the position thereof and the orientation thereof on the first mat conveyor (20); the mutual orientation between the articles (A) and the scraps (S) not removed from the first mat conveyor (20) is maintained.

This enables, in the following operating steps, contemporaneously collecting all the cut articles (A) positioned on the first mat conveyor (20) then to be positioned on the base (75) in order to identify first layer of articles (A) having predefined positions.

Following the transfer of the successive identical articles (A), fashioned by the cutting of the further panels (P) and freed of the scraps (S) thereof, stacks (200) of the articles (A) will be identified, with each stack constituted by identical and superposed articles.

The method of the invention is further advantageous in that, following the management of the unit (5) and the collecting organ (80) it is possible to carry out, in phase relation, the removal of the scraps (S) and the collection of the articles (A): there is, therefore, a zonal collection, with the zones being identified virtually in a series of transversal strips into which the panel (P) is sub-divided.

A variant of the method of the invention, according to the indications of the cutting file, can include collecting at least one article (A) at a time from the cut panel (P) by separating the panel from the adjacent cut articles (A) and/or scraps (S), without altering the orientation and mutual positioning of the cut articles (A) of the panel not removed from the support of the station, and the scraps (S) arranged on the support, with a subsequent transfer of the at least an article (A) into the second station to define stacks of articles, with each stack (200) constituted by identical and superposed articles (A), and the following removal, as a function of the collection of the preceding step, of the scraps (S) from the cut panel (P), with a following transfer of the scraps (S) into a scrap receiving station (S). The machine (1) utilised for actuating the method has particularly advantageous characteristics; the conformation thereof is such that it can be positioned close by known devices for cutting panels.

The transfer of the cut panel (P) takes place by a simple transfer of the panel (P) from the outlet of the devices to the inlet of the machine (1).

The fact of including a scrap removal and unloading unit (5) positioned on the first mat conveyor (20), longitudinally movable from a first non-operating position, in which it is located at the downstream end of the first mat conveyor 20, to intermediate operating positions of advancement above the cut panel (P) resting on the first mat conveyor (20), is advantageous, as following the indications included in the cutting file, relative to the dimensions, the position and the orientation of the cut articles (A), the unit (5) can be positioned above the zones of the panel (P) in which the scraps (S) to be removed are present.

The removal of the scraps (S) will take place by moving the gripping means (9) as a function of the dimensions and orientation of the scraps (S) to be removed: these movements enable the removal of the scraps (S) with high precision and avoiding the displacement of the articles (A) adjacent to the scraps (S) with all the advantages that this brings for the following stacking of the articles (A) on the base (75).

The fact of including a second mat conveyor (30) conformed as previously described is advantageous, as when the second mat conveyor (30) follows the movement of the scrap removal and unloading unit (5), this enables the gripping means (9) to position the scraps (S) removed on the second mat conveyor (30).

The fact of including the collection of the articles (A) with an aspirating plane is advantageous, as with a single operating step all the articles (A) present on the first mat conveyor (20) can be picked up and, with a single operating step following the first, they can be unloaded on the base (75) to define, on the base, layers of articles (A) which will define a series of stacks of the cut articles (A) ready for the following operations.

In a variant embodiment, the scrap removal and unloading unit (5) can be blocked together with the head portion of the collecting organ (80) to define a single set to carry out the same operations as described in the foregoing, i.e. removing the scraps (S), by activating the pick-up groups (6), unloading the scraps (S) in the collecting station, by activating the second mat conveyor (30) and lastly picking up the articles (A) resting on the first mat conveyor (20) and unloading the articles (A), by activating the collecting organ (80), on the base (75).

It is understood that the foregoing has been described by way of non-limiting example and that any modifications in detail, and variants of form and dimensions of the devices, organs and units as described, and any technical-functional variants of the steps of the method are understood to fall within the same protective scope, as claimed in the following.

1. A method for collecting, from a cut panel for obtaining predetermined articles, the articles and scraps generated by the cutting of the panel comprising following steps:
a) making available a cut panel in which predetermined articles and scraps are defined;
b) having available an electronic processor;
c) having available at least a cutting file in which the dimensions, positioning and orientation of the articles and scraps are defined;
d) memorising the cutting file in the electronic processor;
e) positioning the cut panel on a support of a first station;
f) removing, in accordance with the indications of the cutting file, at least one scrap at a time from the cut panel by separating the adjacent cut articles and/or scraps, without altering the orientation and mutual positioning of the cut articles of the panel arranged on the support of the first station and the scraps not removed from the support, transferring the at least a scrap into a scrap collecting station.

2. The method of claim 1, further comprising, following step f), a step g) comprising collection, actuated as a function of the removal of the preceding step, of the articles from the cut panel, with a following transfer of the articles, without changing orientation and mutual positioning thereof, into a second station so as to define a layer of a series of stacks, each stack being constituted by identical and superposed articles.

3. The method of claim 2, wherein the step g) of collecting the articles from the cut panel is actuated in phase relation with step f) of removal of the scraps from the cut panel.

4. The method of claim 2, wherein the step g) of collecting the articles from the cut panel is actuated following completion of step f) of removal of the scraps from the cut panel.

5. The method of claim 1, wherein the step f) of removal of the scraps from the cut panel is actuated simultaneously on all the scraps from the cut panel.

6. The method of claim 4, wherein the step g) of collecting the articles from the cut panel is actuated contemporaneously on all the articles of the cut panel.

7. A method for collecting, from a cut panel for obtaining predetermined articles, the articles and scraps generated by the cutting of the panel comprising following steps:
a) making available a cut panel in which predetermined articles and scraps are defined;
b) having available an electronic processor;
c) having available at least a cutting file in which the dimensions, positioning and orientation of the articles and scraps are defined;
d) memorising the cutting file in the electronic processor;
e) positioning the cut panel on a support of a first station;
f) collecting, in accordance with the indications of the cutting file, at least one article at a time from the cut panel by separating the cut panel from the adjacent cut articles and/or scraps, without altering the orientation and mutual positioning of the cut articles of the panel not removed from the support of the station, and the scraps arranged on the support, with a subsequent transfer of the at least an article into a second station to define a layer of a series of stacks, with each stack constituted by identical and superposed articles.

8. The method of claim 7, further comprising, following step f), a step g) comprising removal, actuated as a function of the collection of articles of the preceding step, of at least one scrap at a time from the cut panel, separating the cut panel from the adjacent cut articles and/or scraps, without altering the orientation and mutual positioning of both thereof, with a subsequent transfer of at least a scrap into a scrap receiving station.

9. The method of claim 8, wherein the step g) of removing the scraps from the cut panel is actuated in phase relation with step f) of collection of the articles from the cut panel.

10. The method of claim 8, wherein the step g) of removing the scraps from the cut panel is actuated following completion of step f) of collection of the articles from the cut panel.

11. The method of claim 7, wherein the step f) of collecting the articles from the cut panel is actuated simultaneously on all the articles from the cut panel.

12. The method of claim 10, wherein the step g) of removing the scraps from the cut panel is actuated contemporaneously on all the scraps of the cut panel.

13. A machine for collecting, from a cut panel for obtaining predetermined articles, the articles and scraps generated by the cutting of the panel, the machine comprising:
an electronic processor, in which a cutting file of a panel is memorised, comprising information relating to the dimensions, positioning and orientation of the articles and the relative scraps present in the panel;
a first station, fed in an advancement direction, with a cut panel in which predefined articles and scraps are defined;
a unit controlled by the processor according to the information of the cutting file, for removing the scraps from the panel and directing them into a collecting station, external of the first station, keeping the positioning and orientation of the cut articles arranged in the first station unaltered;
a second station located downstream of the first station; and
a collecting organ which collects the articles in the first station in order to transfer them to the second station onto which they are released and stacked on a base of the second station.

14. The machine of claim 13, wherein the unit comprises:
a first device for removing the scraps from the cut panel, located above the first station; and
a second device, located above the first station, for receiving the scraps of the first device so as to direct the scraps towards the collecting station.

15. The machine of claim 14, wherein the first station comprises a first mat conveyor.

16. The machine of claim 14, wherein the second device comprises a second mat conveyor arranged transversally to the advancement direction of the cut panel to the first station.

17. The machine of claim 14, wherein the first and second devices are activated in mutual phase relation in the direction identified by the advancement direction of the cut panel to the first station.

18. The machine of claim 17, wherein the first and second device are activated in synchrony.

19. The machine of claim 14, wherein the first device comprises:
a beam, transversal to the advancement direction of the cut panel to the first station, on which at least a guide is included, transversal to the advancement direction;
at least a bar, parallel to the advancement direction, of which an end is provided with at least a skate sliding on the guide; and
at least a pick-up group borne by the bar.

20. The machine of claim 19, wherein the pick-up group comprises:
at least a carriage, sliding on the bar; a rod, borne by the carriage, sliding vertically; and
gripping means of the scraps, borne by the lower end of the rod.

21. The machine of claim 20, wherein the gripping means rotate, in both directions, with respect to a vertical axis.

22. The machine of claim 13, wherein the collecting organ comprises an aspirating plane, the aspirating face being turned downwards, and being mobile both longitudinally, according to the direction identified by the advancement direction of the cut panel to the first station, and vertically.

23. The machine of claim 22, wherein the aspirating plane can rotate with respect to a vertical axis.

24. The machine of claim 13, wherein the second station is identified by the base of an elevator.
